(19) United States
(12) Patent Application Publication
(10) Pub. No.: US 2016/0102243 A1
(43) Pub. Date: Apr. 14, 2016

(54) EXPANDABLE PROPPANT

(71) Applicant: SCHLUMBERGER TECHNOLOGY CORPORATION, SUGAR LAND, TX (US)

(72) Inventor: Ini Abasiattai, Pearland, TX (US)

(21) Appl. No.: 14/513,860

(22) Filed: Oct. 14, 2014

(51) Int. Cl. C09K 8/80; E21B 43/267

(52) U.S. Cl. CPC C09K 8/80; E21B 43/267

(57) ABSTRACT

A method of treating a subterranean formation includes injecting an expandable proppant fluid into a wellbore, wherein the expandable proppant fluid comprises an expandable material; introducing the expandable proppant fluid into the subterranean formation through the wellbore; and increasing the diameter of the expandable material in the expandable proppant fluid from a first diameter to a second diameter after introduction into the subterranean formation.

### BACKGROUND

Hydrocarbons (oil, natural gas, etc.) are obtained from a subterranean geologic formation (i.e., a “reservoir”) by drilling a well that penetrates the hydrocarbon-bearing formation. The well provides a partial flowpath for the hydrocarbon to reach the surface. In order for the hydrocarbon to be “produced,” that is travel from the formation to the wellbore (and ultimately to the surface), there must be a sufficiently unimpeded flowpath from the formation to the wellbore.

Hydraulic fracturing is a primary tool for improving well productivity by creating or extending fractures or channels from the wellbore to the reservoir. Pumping of propping granules, or proppants, during the hydraulic fracturing of oil and gas containing earth formations may enhance the hydrocarbon production capabilities of the earth formation. Hydraulic fracturing injects a viscous fluid into an oil and gas bearing earth formation under high pressure, which results in the creation or growth of fractures within the earth formation. These fractures serve as conduits for the flow of hydrocarbons trapped within the formation to the wellbore. To keep the fractures open and capable of supporting the flow of hydrocarbons to the wellbore, proppants are delivered to the fractures within the formation by a carrier fluid and fill the fracture with a proppant pack that is strong enough to resist closure of the fracture due to formation pressure and also permeable for the flow of the fluids within the formation.

The flow of reservoir fluids from the rock into the reservoir may be enhanced due to high permeability of the proppant in the resulting crack. The larger the diameter of the proppant particles the greater the inflow through the fracture, all other conditions remaining unchanged. However, it may be more challenging to place larger proppant particles ‘inside such cracks generated by hydraulic pressure. Bridging may occur as the proppant slurry with the larger proppant particles reaches the entrance to the crack due to the large size of proppant particles relative to the crack opening. Furthermore, the cost of pumping the larger diameter proppant particles along with the maintenance of the pump equipment may discourage the use of larger diameter proppant particles.

It is desired to increase the flowability of the recoverable fluid by increasing the permeability of the interstitial channels between adjacent proppant particles within the proppant matrix.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of treating a subterranean formation includes injecting an expandable proppant fluid into a wellbore, wherein the expandable proppant fluid comprises an expandable material; introducing the expandable proppant fluid into the subterranean formation through the wellbore; and increasing the diameter of the expandable material in the expandable proppant fluid from a first diameter to a second diameter after introduction into the subterranean formation.

In another aspect, embodiments disclosed herein relate to a fluid for use in hydraulic fracturing. The fluid includes a carrier fluid and a proppant material having expandable particles whose diameter may be increased from a first diameter to a second diameter.

Other aspects and advantages of the claimed subject matter will be apparent from the following description and the appended claims.

### BRIEF DESCRIPTION OF DRAWINGS

FIG. 1 is a flowchart for a method of hydraulic fracturing according to embodiments herein.

FIG. 2 is a flowchart for a method of hydraulic fracturing in a cased well according to embodiments herein.

FIG. 3 is a flowchart for a method of hydraulic fracturing in a reservoir with a pinch point according to embodiments herein.

### DETAILED DESCRIPTION

In one aspect, embodiments disclosed herein relate to fracturing fluid including an expandable proppant. The expandable proppant is pumped downhole and has expandable material having a first diameter which may be increased to a second diameter. The increase in the diameter may occur due to thermal activation, chemical activation, time-activation or a combination of these.

In general, hydraulic fracturing treatment methods are considered to have several distinct stages. During the first stage a hydraulic fracturing fluid is injected through a wellbore into a subterranean formation at high rates and pressures. Upon reaching a threshold value, the pressure causes the formation strata or rock to crack and fracture. As the injection of fracturing fluid continues the fractures and cracks propagate further into the formation. During a second stage, proppant is admixed into the fracturing fluid and transported throughout the hydraulic fractures. In this way, proppant may be deposited throughout the length of the created fractures and serves to mechanically prevent the fracture from closing after the injection, and the pressure supplied thereby, stops.

In some embodiments, the placement of proppant within the fractures is accomplished by pumping alternating stages of substantially proppant-free and proppant-laden fracturing fluid through a wellbore and into the fracture network. The alternating proppant stages may be created by appropriate surface equipment prior to their delivery downhole. Hydraulic fracturing processes including the injection of alternating stages of fracturing fluid substantially free of proppant and proppant-laden fracturing fluid may create heterogeneous proppant structures and a system of substantially open channels within the fracture network. The heterogeneously placed proppant structures and the system of open channels within the fracture formed thereby may allow for a high fracture conductivity and improved production of hydrocarbons from the formation.

Embodiments disclosed provide an expandable proppant material useful in proppant placement during a hydraulic fracturing operation. As used herein, the term “expandable” typically refers to the ability of a material to increase in, for example, size and/or volume. The expandable proppant material may have a first (initial) diameter. In some embodiments, the expandable proppant material may expand by, for example, by contact with an expanding agent such as water and/or other fluids. In other embodiments, the expandable proppant material may expand by, for example, undergoing a chemical reaction or being exposed to heat and/or pressure. In some embodiments, the heat and/or pressure may be provided by the formation itself. In other embodiments, the chemical reaction may be initiated by contact with an additive or catalyst pumped downhole. After expansion, the expandable proppant material may have a second (final) diameter. In some embodiments, the first diameter is smaller than the second diameter. The expandable proppant may be capable of increasing at least 200% of the volume of the completely unexpanded, expandable material.

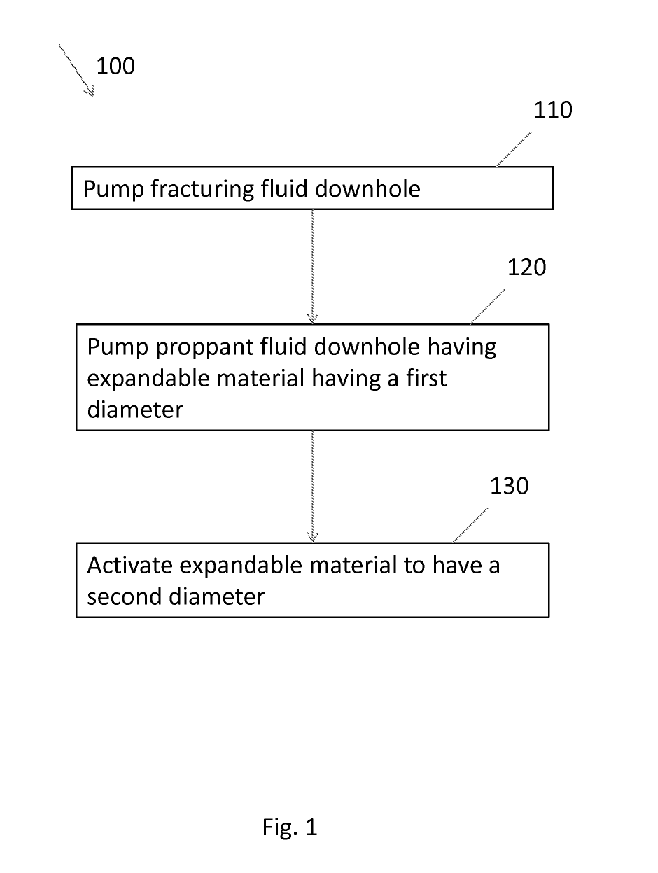

In some embodiments, the expandable proppant material may be used during hydraulic fracturing of a subterranean formation. The hydraulic fracturing may stimulate oil reservoirs to allow oil and/or gas to flow properly. A method 100 of hydraulic fracturing, as shown in FIG. 1, includes injecting fracturing fluids into the well bore 110, at a rate sufficient to increase the pressure down hole to a value in excess of the fracture gradient of the formation thereby forming fractures. The pressure from the injection of the fracturing fluid may cause the formation rock to crack which allows the fracturing fluid to enter cracks and extend the cracks further into the formation. Once the fractures are formed, solid proppant materials are added to further injections of the fracturing fluid in order to keep the fracture open. The solid proppant material, commonly a sieved rounded sand article, may be introduced into the fractures. When the fracturing pressures are removed the solid proppant particles present in the fractures prevent the fractures from closing. The fractures obtained and kept open with the solid proppant particles provide a permeable means through which the oil and/or gas can be extracted from the reservoir. The permeability of the proppant materials in the fracture enhances the flow of the reservoir fluids. Larger diameter proppant material may enhance the production of the reservoir. In some embodiments, a proppant fluid including expandable proppant material may be pumped downhole 120. The expandable proppant material will have a first diameter. After placement within the fracture, the diameter of the expandable proppant material is increased to a second diameter via activation of the expandable material 130. By placing the smaller diameter expandable proppant material downhole, the expandable proppant material enters the fracture and upon increasing the diameter of the expandable proppant material an increase in the inflow of the reservoir fluid to the wellbore may be achieved. By pumping the expandable proppant material having a smaller diameter downhole, typical pumping equipment may be used. Smaller proppant material may provide a smoother slurry flow with minimal mechanical impact on the pumping equipment due to liquid enveloping the smaller proppant material. Pumping larger proppant material may damage the pumping equipment due to the grain to grain contact. The activation of the expandable material in the proppant material may be achieved via a chemical reaction, a temperature differential, a pressure differential, or a combination thereof.

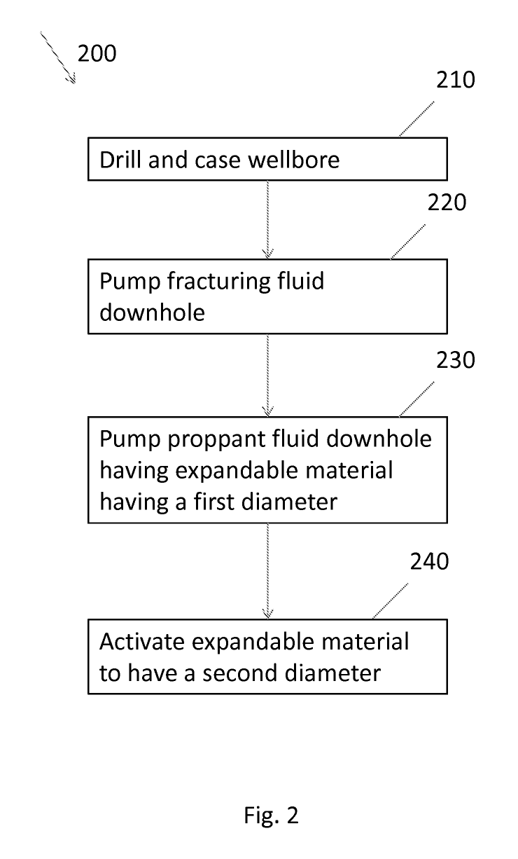

In some instances, fracturing may be desired after a wellbore has been drilled. A wellbore's production may decrease after some time due to decreasing pressure and it may be desired to fracture the reservoir outside of a cased wellbore to increase the production of the wellbore. Cased wellbore typically has perforations therein to allow the of hydrocarbons from the formation. As shown in FIG. 2, a method 200 for hydraulic fracturing in a cased well includes, drilling and casing a wellbore 210. The drilling and casing a wellbore 210 may also include perforating the casing. Fracturing fluid may be pumped downhole 220. Typically, the wellbore includes casing having a plurality of perforations. The diameter of the perforations may limit the size of the proppant which may be used in the hydroaulic fracturing. By using a proppant fluid including an expandable proppant material, the expandable proppant material may have a first diameter which will be able to be pumped out of the perforations of the casing 230. In some embodiments, the slurry concentration of the proppant material in a fluid may be about 6 lbₘ/gal fluid which results in the perforation diameter having to be about 5.5. times larger than the proppant material diameter. After placement within the fracture, the diameter of the expandable proppant material may be activated to increase to a second diameter 240. The larger diameter proppant material may allow an increase in the flow of the reservoir fluid to the wellbore. The second diameter of the expandable proppant material is typically larger than the casing perforations. The activation of the expandable material in the proppant material may be achieved via a chemical reaction, a temperature differential, a pressure differential, or a combination thereof.

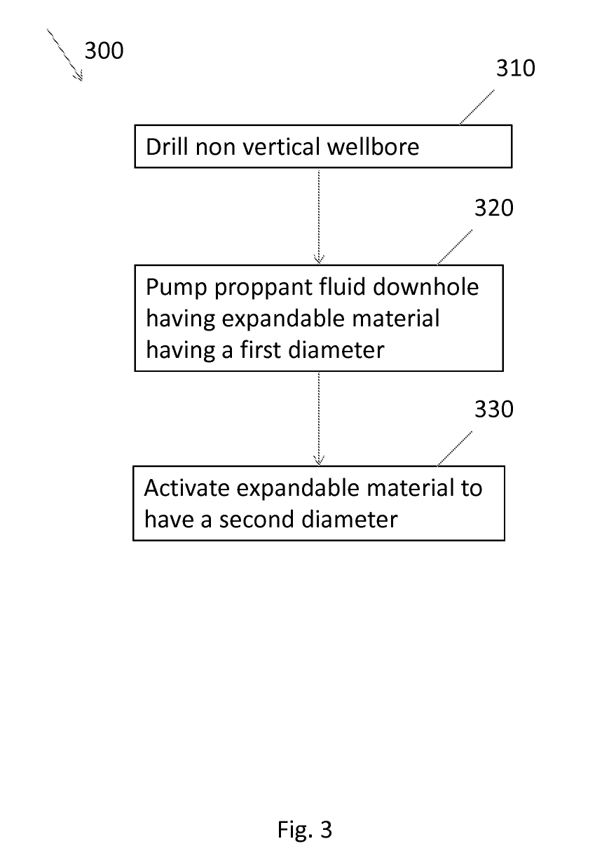

Expandable proppants may also be used during hydraulic fracturing if a pinch point occurs. As a result of the offset between the wellbore axis and the created fracture plane, a pinch point may be created. The fracture neck, which may also be known as the pinch point, and the fluid flow path from the wellbore out of the perforations and into the fraction may be curved due to the differences in horizontal and vertical stresses. In some embodiments, the width of the fracture neck may change because the part of the fracture neck stemming from the wellbore may experience a greater force, thereby producing a fracture width less than a desired proppant size at the neck of the fracture. Therefore, pumping in an expandable proppant material having a first diameter small enough to be pumped past the pinch point may be desired. Fracture width at the neck may be determined by geo mechanics. A method 300 of using proppant in a hydraulic fracturing reservoir having a pinch point is shown in FIG. 3. A non-vertical wellbore is drilled 310. The misalignment of the flowpath may limit the size of the proppant material which can be pumped past the pinch point, therefore, one skilled in the art can determine the fracture width at the pinch point using geo mechanics to provide diameters of proppant to use in the fracture. Fluids having proppant material with a large diameter may get trapped prior to the “pinch point.” By pumping an expandable proppant material into the fracture 320, the expandable proppant material with a first diameter is capable of passing past the pinch point in the fracture. After placement within the fracture, activation of the expandable proppant 330 increases the expandable proppant material to a second diameter at a location past the pinch point. After activation, the larger diameter proppant may increase the inflow of the reservoir fluid to the wellbore. The second diameter of the expandable proppant material is typically larger than the diameter of the pinch point. The activation of the expandable material in the proppant material may be achieved via a chemical reaction, a temperature differential, a pressure differential, or a combination thereof.

In embodiments disclosed, the proppant may include an expandable proppant material. The expandable proppant material may have a spherical shape, but other shapes such as a wire segment, ribbon or fibers having a non-constant diameter may also be used. Expandable proppant materials may have sphericity and roundness values exceeding 0.8. In some embodiments of the present disclosure, a portion of or substantially all of the expandable proppant material may have a sphericity less than about 0.8 or 0.7 according to a Krumbein chart. In some embodiments, a portion of or substantially all of the expandable proppant material may have a roundness less than about 0.8 or 0.7 according to a Krumbein chart. In yet other embodiments, substantially all of the expandable proppant material may have a sphericity and roundness less than about 0.7 according to a Krumbein chart. The Krumbein chart is a measurement of the particle size, also called grain size, referring to the diameter of individual grains of sediment, or the lithified particles in clastic rock.

In other embodiments, the expandable proppant material may be substantially non-spherical and may be cubic, polygonal, fibrous, or any other non-spherical shape. Such substantially non-spherical proppant material may be, for example, cubic-shaped, rectangular-shaped, rod-shaped, ellipse-shaped, cone-shaped, pyramid-shaped, or cylinder-shaped. That is, in embodiments wherein the proppant material is substantially non-spherical, the aspect ratio of the material may range such that the material is fibrous to such that it is cubic, octagonal, or any other configuration. Substantially non-spherical proppant materials are generally sized such that the longest axis is from about 0.02 inches to about 0.3 inches in length. In other embodiments, the longest axis is from about 0.05 inches to about 0.2 inches in length. In one embodiment, the substantially non-spherical proppant material are cylindrical having an aspect ratio of about 1.5 to 1 and about 0.08 inches in diameter and about 0.12 inches in length. In another embodiment, the substantially non-spherical proppant materials are cubic having sides about 0.08 inches in length. The use of substantially non-spherical proppant material may be desirable in some embodiments because, among other things, they may provide a lower rate of settling when slurried into a fluid as is often done to transport proppant material to desired locations within subterranean formations. It is within the ability of one of ordinary skill in the art, with the benefit of this disclosure, to determine the size and shape of proppant material to include in the methods of the present disclosure.

When substantially spherical, the expandable proppant material may have a first (i.e., initial) diameter ranging from about 0.1 mm to about 1 mm. In some embodiments the expandable proppant material may have a second diameter (i.e., final) diameter (or equivalent diameter where the base is not circular) ranging between about 0.1 mm and about 1 mm and most preferably between about 0.2 mm and about 0.5 mm. The size of the proppant, prior to expanding, may range from about 4 U.S. Mesh (4.75 mm) to 35 U.S. Mesh (0.5 mm). The size of the proppant, after expanding, may range from about 4 U.S. Mesh (4.75 mm) to 35 U.S. Mesh (0.5 mm). In some embodiments, the proppant particulates have a size in the range of from about 20 to about 180 Mesh, U.S. Sieve Series. It must be understood that depending on the process of manufacturing, small variations of shapes, lengths and diameters are normally expected. In some embodiments, the first diameter of the expandable proppant material should be within about 5% of the second diameter of the expandable proppant material.

To activate the expansion of the expandable proppant material from a first diameter to a second diameter, a chemical reaction may occur. The chemical reaction may occur due to the expandable proppant material coming in contact with one or more reservoir fluids, e.g., hydrocarbon fluid, fresh water, or saline water, or one or more injected reaction fluids, e.g. fresh water, saline water, carbon dioxide, hydrogen peroxide, aqueous soluble acids, or aqueous soluble bases.

In other embodiments, the activation of the expansion of the expandable proppant material from a first diameter to a second diameter may occur to a change in the temperature and/or pressure. The temperature and pressure increase within a formation, the farther from the surface the drilling goes. In other embodiments, the activation of the expansion of the expandable proppant may be time dependent, such that after a given time the expandable proppant will expand from the first diameter to the second diameter. For example, after pumping the proppant downhole, the expansion would occur after about 30 minutes, about 60 minutes, or longer, depending on the location of the fracture from the surface and pumping requirements.

Proppant particulates suitable for use in the present invention may comprise any material suitable for use in subterranean operations. Suitable materials for these proppant particulates include, but are not limited to, sand, bauxite, ceramic materials, glass materials, polymer materials (such as EVA or composite materials), polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and any combinations thereof. Suitable composite particulates may comprise a binder and a filler material wherein suitable filler materials include silica, alumina, fumed carbon, carbon black, graphite, mica, titanium dioxide, barite, meta-silicate, calcium silicate, kaolin, talc, zirconia, boron, fly ash, hollow glass microspheres, solid glass, and any combinations thereof.

The present invention provides an expandable proppant material that may be an expandable organic polymer suitable for use in treating a subterranean formation. The expandable organic polymer may be water-swellable and may possess two configurations: a expanded configuration when contacted with a reaction fluid and an unexpanded configuration in the absence of reaction fluid. Suitable sources of reaction fluid that may cause the expandable organic polymer to expand include, but are not limited to, hydrocarbon fluid, carbon dioxide, hydrogen peroxide, aqueous soluble acids, aqueous soluble bases, fresh water, brackish water, seawater, brine, and any combination thereof in any proportion. The expandable organic polymer may be used alone as expandable organic particulates or may be coated onto proppant particulates as expandable organic polymer coated proppant particulates. In some embodiments, the unswelled configuration of the expandable organic polymer particulate or the expandable organic polymer coated proppant particulate has a size distribution range such that at least 90% of the expandable organic polymer particulate or the expandable organic polymer coated proppant particulate has a size of about 0.01 mm to about 5 mm. In the swelled configuration, the expandable organic polymer particulate or the expandable organic polymer coated proppant particulate may have a size of about 30 times its original size. In other embodiments, a catalyst may be used to interact with the expandable proppant to start the activation to increase the diameter of the expandable proppant.

Suitable expandable organic polymers include, but are not limited to, cross-linked polyacrylamide, cross-linked polyacrylate, cross-linked copolymers of acrylamide and acrylate monomers, starch grafted with cross-linked acrylonitrile and acrylate, cross-linked polymers of two or more of allylsulfonate, 2-acrylamido-2-methyl-1-propanesulfonic acid, 3-allyloxy-2-hydroxy-1-propanesulfonic acid, acrylamide, acrylic acid monomers, salts of cross-linked polymeric material, copolymers of a cross-linked vinyl silane and at least one water soluble organic monomer, cross-linked cationic water soluble polymers, and any combination thereof in any proportion. Typical examples of suitable salts of cross-linked polymeric material include, but are not limited to, salts of carboxyalkyl starch, salts of carboxymethyl starch, salts of carboxymethyl cellulose, salts of cross-linked carboxyalkyl polysaccharide, starch grafted with acrylonitrile and acrylate monomers, and any combination thereof in any proportion. Typical examples of suitable cross-linked copolymers of vinyl silane include, but are not limited to, vinyltrichlorosilane, vinyltris(beta-methoxyethoxy)silane, vinyltriethoxysilane, vinyltrimethoxysilane, methacrylatetrimethoxysilane, methacrylatetriethoxysilane, and any combinations thereof. Suitable water soluble organic monomers for use with the cross-linked copolymers of vinyl silane include, but are not limited to, 2-hydroxyethyl acrylate, polyalkylacrylate, acrylamide, vinylmethyl ether, methacrylamide, vinylpyrrolidone, and any combinations thereof. Suitable cross-linked cationic water soluble polymers include, but are not limited to, quaternized ammonium salt of polydialkyldiallyl polymers, quaternized ammonium salt of polyethyleneimine polymers, quaternized ammonium salt of polydimethylaminoethyl-methacrylate copolymers, quaternized ammonium salt of poly N-(3-dimethylaminopropyl)acrylamide polymers, and any combinations thereof. The specific features of the expandable organic polymer may be chosen or modified to provide a proppant pack with desired permeability while maintaining adequate propping and filtering capability.

The expandable proppant may also be a proppant particle substrate coated with a hydrogel-forming polymer such as that described in U.S. Patent Publication No. 20140228258, the specifications of which is hereby incorporated in their entirety. The modified proppant may be a proppant particle having a hydrogel coating. The hydrogel coating may localize on the surface of the proppant particle to produce the modified proppant. The proppant particles can be solids such as sand, bauxite, sintered bauxite, ceramic, or low density proppant. Alternatively or additionally, the proppant particle may be a resin-coated substrate.

In an alternate embodiment, the expandable proppant may be an organic polymer that expands when contacted with an activating agent in particulate form (“expandable organic polymer particulate”) or as a proppant particulate coating (“expandable organic polymer coated proppant particulate”) such as that described in U.S. Patent Publication No. 20140083696, the specification of which is hereby incorporated in their entirety.

In some embodiments, the expandable proppant materials may be include an expandable filler materials include natural rubber, acrylate butadiene rubber, polyacrylate rubber, isoprene rubber, choloroprene rubber, butyl rubber, brominated butyl rubber, chlorinated butyl rubber, chlorinated polyethylene, neoprene rubber, styrene butadiene copolymer rubber, sulphonated polyethylene, ethylene acrylate rubber, epichlorohydrin ethylene oxide copolymer, ethylene-propylene rubber, ethylene-propylene-diene terpolymer rubber, ethylene vinyl acetate copolymer, fluorosilicone rubbers, silicone rubbers, fluoro rubbers, poly 2,2,1-bicyclo heptene, alkylstyrene, crosslinked substituted vinyl acrylate copolymers, and diatomaceous earth.

In other embodiments, the expandable filler material is selected from the group consisting of: boric oxide, poly(acrylamide), poly(lactide), poly(glycolide), protein, chitin, cellulose, dextran, poly(ε-caprolactone), poly(hydroxybutyrate), poly(anhydride), aliphatic polycarbonate, poly(orthoester), poly(amino acid), poly(ethylene oxide), polyphosphazene, derivatives thereof, and combinations thereof, such as as described in U.S. Patent Publication No. 20140020893, the specification of which is hereby incorporated in their entirety.

The expandable proppant may also be a clay having montmorillonite therein. As noted in the article “The Effect of Temperature on the Swelling of Montmorillonite” in Clay Minerals 1993, 28, 25-31, temperature and pressure are known to swell soils having clay particles and therefore may be used as an expandable proppant. The expandable proppant may also be a red clay based ceramic slurry, such as that disclosed in “Starch consolidation of red clay-based ceramic slurry inside a pressure-cooking system” in Materials Research, vol. 17, no. 1 Sao Carlos January/February 2014 Epub Oct. 8, 2013. The heating of a red clay results in rapid and irreversible swelling of the starch granules. In some embodiments, the clay may be pumped downturn and allowed to sit for a period of time sufficient to allow for swelling to occur.

Suitable base fluids for the proppant fluid may include, but are not limited to, aqueous-based fluids, aqueous-miscible fluids, water-in-oil emulsions, or oil-in-water emulsions. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols, e.g., methanol, ethanol, n-propanol, isopropanol, n-butanol, sec-butanol, isobutanol, and t-butanol; glycerins; glycols, e.g., polyglycols, propylene glycol, and ethylene glycol; polyglycol amines; polyols; any derivatives thereof; any in combination with salts, e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate; any in combination with an aqueous-based fluid; and any combinations thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset there between. In some embodiments, the expandable particles are present in the proppant fluid in an amount of about 30% to 50% by weight of the proppant fluid. Examples of suitable invert emulsions include those disclosed in U.S. Pat. Nos. 5,905,061, 5,977,031, 6,828,279, 7,534,745, 7,645,723, and 7,696,131, each of which are incorporated herein by reference. It should be noted that for water-in-oil and oil-in-water emulsions, any mixture of the above may be used including the water being and/or comprising an aqueous-miscible fluid.

In certain embodiments, the pH of the proppant fluid may be adjusted (e.g., by a buffer or other pH adjusting agent). In these embodiments, the pH may be adjusted to a specific level, which may depend on, among other factors, the types of additives included in the proppant fluid. Additives suitable for use in the present invention may include, but are not limited to, viscosifying agents, buffering agents, pH adjusting agents, biocides, bactericides, friction reducers, solubilizer, or any combinations thereof. One of ordinary skill in the art, with the benefit of this disclosure, will recognize when such pH adjustments or additives are appropriate.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method of treating a subterranean formation comprising:
injecting an expandable proppant fluid into a wellbore, wherein the expandable proppant fluid comprises an expandable material;
introducing the expandable proppant fluid into the subterranean formation through the wellbore; and
increasing the diameter of the expandable material in the expandable proppant fluid from a first diameter to a second diameter after introduction into the subterranean formation,
wherein the wellbore comprises a casing including a plurality of perforations having a diameter smaller than the second diameter of the expandable material.

2. The method of claim 1, further comprising fracturing the subterranean formation prior to injecting the expandable material.

3. The method of claim 1, wherein introducing the expandable proppant fluid comprises pumping the expandable proppant fluid, wherein the pump is sized for the expandable material having the first diameter.

4. The method of claim 1, wherein the increasing the diameter of the expandable material comprises heating the expandable material.

5. The method of claim 4, wherein heating the expandable material comprises utilizing the heat of the subterranean formation to increase the temperature of the expandable material.

6. The method of claim 1, wherein the increasing the diameter of the expandable material comprises further comprises contacting an additive with the expandable material.

7. The method of claim 6, wherein the contacting the additive comprises introducing the additive into the subterranean formation to mix with the expandable proppant fluid.

8. The method of claim 1, wherein the increasing the diameter comprises activating a catalyst within the expandable proppant fluid.

9. The method of claim 1, wherein the increasing the diameter is performed about 30 minutes after injecting the expandable proppant.

10. The method of claim 1, wherein the plurality of perforations is about 5.5 times larger than the first diameter of the expandable material.

11. The method of claim 1, wherein the introducing the expandable proppant fluid further comprises introducing the expandable proppant fluid past a pinch point in the subterranean formation before increasing the diameter of the expandable material.

12. A fluid for use in hydraulic fracturing, comprising:
a carrier fluid; and
a proppant material comprising expandable particles whose diameter may increase from a first diameter to a second diameter.

13. The fluid of claim 12, wherein the expandable particles have a second volume related to the second diameter, the second volume at least 200% of a first volume, the first volume related to the first diameter.

14. The fluid of claim 12, wherein the expandable particles diameter increases in response to an increase in the temperature of the carrier fluid.

15. The fluid of claim 14, wherein the increased temperature of the carrier fluid is from a subterranean formation.

16. The fluid of claim 12, wherein the expandable particles diameter increases in response to a chemical reaction.

17. The fluid of claim 12, wherein the expandable particles diameter increases in response to contact with an activating agent.

18. The fluid of claim 12, wherein the first diameter of the expandable particles is within 5% of the second diameter of the expandable particles.

19. The fluid of claim 12, wherein the expandable particles are present in the carrier fluid in an amount of about 30% to 50% by weight of the carrier fluid.

20. The fluid of claim 12, wherein the fluid comprises about 6 lbₘ of proppant per gal expandable carrier fluid.
